(19) United States
(12) Patent Application Publication
(10) Pub. No.: US 2002/0038299 A1
(43) Pub. Date: Mar. 28, 2002

(54) Interface for presenting information

(76) Inventors: Uri Zernik, Palo Alto, CA (US); Dror Zernik, Haifa (IL); Doron Myersdorf, Foster City, CA (US)

Correspondence Address: RITTER VAN PELT & YI, L.L.P., 4906 EL CAMINO REAL, SUITE 205, LOS ALTOS, CA, 94022

(21) Appl. No.: 09/764,336

(22) Filed: Jan. 16, 2001

Related U.S. Application Data
(60) Provisional application No. 60/190,848, filed on Mar. 20, 2000.

(51) Int. Cl. G06F 7/00

(52) U.S. Cl. 707/3

(57) ABSTRACT

A system and method are disclosed for presenting information. Categories are determined for found information by analyzing the content of the information. The categories are correlated with images that represent the categories. Images are displayed that correspond to the categories.

### FIELD OF THE INVENTION

The present invention relates generally to displaying search results. More specifically, providing a visual or multi-media representation of search results is disclosed.

### BACKGROUND OF THE INVENTION

A variety of techniques for identifying records in a database that are responsive to a query submitted by a user are well known. One well known application of such techniques is their use in providing an Internet search engine to identify potentially relevant pages on the World Wide Web (referred to herein as “web pages”) in response to a query submitted by a searching party.

It is well known that in order to be able to quickly identify web pages responsive to a query, one must first search tens of millions or hundreds of millions of the many millions of web pages accessible via the Internet and create a database containing information about each page. The information contained in such a database typically includes the address of the web page, such as the Uniform Resource Locator (URL) (i.e., the information a web browser would need to access the page) and one or more keywords associated with the page. The information in the database is used to identify web pages that may contain information that is responsive to a query submitted by a requesting party, such as by matching a term in a search query to a keyword associated with a web page.

A typical search engine presents results in the form of a list of responsive web pages. Each entry on the list typically corresponds to a web page, or a group of web pages from a single web site. Typically, a hypertext link is included for each web page listed. Text associated with the page also typically is provided, such as a brief description of the page, key words identified by the provider of the page, or excerpts of potentially relevant text that appears on the page.

In some cases, an effort is made to rank the results using a ranking scheme that is intended to result in the most relevant responsive pages being displayed on the list first. In some cases, well known statistical techniques are used to group at least certain of the responsive pages together into clusters or categories of responsive pages. In at least one case, such categories are displayed to the requesting party in the form of a folder icon for each category with an appropriate title or label on or near the folder icon. When a hypertext link associated with the folder icon is selected, the responsive web pages within the corresponding category are displayed in list form as described above.

The approaches described above for displaying search results have a number of shortcomings. First, the use of text to provide an indication to the requesting party of the content of web pages responsive to a query requires the requesting party to read the text associated with each page and determine whether the text indicates that the web page may contain the information the requesting party is seeking. This process may be time-consuming, depending on how long it takes the individual to read and comprehend the text provided for each responsive page and determine from the text whether or not the page contains the information sought, and how many such descriptions the individual must evaluate before the desired information is found or the individual either gives up or determines the search has not found any web page containing the desired information.

A second shortcoming of the above-described approach is that the text may not provide an accurate or complete indication of the true content of the web page. Much of the information available on the World Wide Web is provided in the form of images such as still pictures, video, audio, animated GIF's or other multimedia content. A textual description or excerpts of text from the page may not provide an adequate indication of such content and, at best, is an inefficient and time-consuming way to represent such content.

This second shortcoming has become even more apparent as increasing numbers of Internet users have gained access to broadband, high speed Internet connections, such as digital subscriber lines (DSL) and cable modem connections. The availability of such connections has accelerated the growth of multimedia content available on the Internet, increasing the need for an effective way to provide a representation of such content. Moreover, search engines that present search results in the form of a list of text entries do not take full advantage of the broadband connections now becoming available to an increasing number of users. Such connections make it possible to quickly and easily view search results displayed using a visual or multimedia representation of each site, such as a collage or slideshow of images, one or more video clips, and/or one or more audio clips from or associated with the content of the site.

Third, the approach described above can result in a tedious and potentially frustrating experience on the part of the requesting party. Reviewing a list of search results in the typical list form is much like reading a phone book or the entries in a card catalog. In many cases, a requesting party may review pages and pages of search results presented in such list form before the entry for the page having the desired information is found on the list. In some cases, the requesting party finds that the search has not identified a page having the desired information only after significant time has been spent reviewing search results in list form.

Finally, the approach described above results in a display that is static and not aesthetically pleasing. Many users are attracted to the Internet because of the visual, multi-media, and dynamic content available on the World Wide Web. Many users accustomed to such dynamic content find the typical search result list display described above to be both unfamiliar and uninteresting compared to other methods of displaying information on the World Wide Web.

It is critical to many providers of search engines that users find the site to be an interesting and aesthetically pleasing experience, as well as a useful and efficient way to find information. Search engine providers want to maximize the likelihood that a user will return to their site for further searches in the future. Advertising provides the only or most significant source of revenue for many such providers, and advertising revenue typically is based on the number of viewers, or “impressions”, a site receives. As a result, search engine providers depend heavily for their commercial success on their ability to attract users to their site.

Search engines have been provided to locate images, video, music, and other multi-media content on the Internet. The image, video, and/or music search engines provide by companies such as AltaVista™, Lycos™, and Ditto™ are typical. In some cases, the results of such searches have been presented in a form other than a list of web pages. In some cases, a thumbnail image of each responsive image retrieved from a database of images, such as images previously located on pages on the World Wide Web, is presented. However, in such cases the thumbnail image is used to represent the full-size image itself, not a web page the content of which is represented by the image, such as a web page that is responsive to a search query.

A visual interface has also been used to enable a user of the Internet to maintain a live HTML connection with more than one web site at a time by displaying multiple active web pages on a single display. Again, this technique has been used only to provide a split screen view for an Internet browser, and not to present a visual representation that quickly apprises a viewer of a display of the nature and content of a web page, such as a web page that is responsive to a search query.

It is also known to employ an advertising agency, graphical artist, or the like to create a set of images to be displayed in a slide show, such as in the banner advertisements that are ubiquitous on the Internet, to advertise a company, product, or service. In some cases, a link is provided in the banner ad to a web site associated with the company, product, or service. However, such slide shows have been used only to provide an advertising message or an inducement to attract users of the Internet to a web site associated with the company, product, or service being advertised. Such slide shows have not been used to our knowledge to provide a visual representation of the actual nature and content of a web page, such as a web page that is responsive to a search query.

Finally, it is known to provide for visual navigation through a site by enabling a user to select icons or images on one page in order to access additional or different information on another page. However, to our knowledge a visual interface has never been used to present the results of a search by providing a visual representation of web pages or categories of web pages, such as web pages or categories of web pages that are responsive to a search query.

Therefore, there is a need for a way to display search results in a manner that enables users to find records, such as web pages, having the information they are seeking quickly and efficiently. In addition, in the Internet environment there is a need for a way to display search results that makes use of the visual and multi-media content available on the World Wide Web. There is also a need to present search results in a way that is familiar and more satisfactory to users of the Internet. Finally, there is a need to present search results in a display that is dynamic, rather than static.

### SUMMARY OF THE INVENTION

Accordingly, an interface for presenting search results is described. Responsive records are identified in response to a search query. Responsive records are grouped into categories of related responsive records, with a multimedia representation-such as a visual representation comprised of one or more images, animations, video segments, audio segments, or other multimedia content-being provided for each category. A multimedia representation of the nature and content of each responsive record within each category also is provided.

It should be appreciated that the present invention can be implemented in numerous ways, including as a process, an apparatus, a system, a device, a method, or a computer readable medium such as a computer readable storage medium or a computer network wherein program instructions are sent over optical or electronic communication links. Several inventive embodiments of the present invention are described below.

In one embodiment, a lexicon embodying information concerning words, phrases, and expression; their meaning; and their semantic and conceptual relations with each other is built. A database of images is collected. A database of pre-determined, or “static”, search result categories is developed. One or more images is associated with each static category. Web pages on the World Wide Web are accessed. Each page is processed to identify a signature for the page and to harvest usable images from the page. Web page signatures and usable images are stored in a database. One or more images are associated with each web page. When a search query is received, Web pages responsive to the search query are identified. Responsive web pages are organized into categories of related responsive web pages. For each category and each responsive web page, one or more associated images are retrieved. The categories and responsive web pages are ranked. A display is provided to the requesting party in which one or more of the search result categories are represented by one or more associated images. By selecting a category, the requesting party accesses a display presenting one or more responsive web pages within the category.

Each responsive web page within a category is represented by one or more images associated with the web page. If one image is used, the display is static. If more than one image is used, the display is dynamic and the images alternate. In one embodiment, more than one image is used to represent each responsive web page and the images are arranged in a slideshow format.

In one embodiment, at least certain of the categories and/or certain of the responsive web pages are represented by one or more segments (or “clips”) of video, audio, and/or other multimedia content. In one embodiment, at least certain of the responsive web pages are represented by one or more segments of video, audio, and/or other multimedia content harvested from the responsive web page.

In one embodiment, the disclosed interface is used in connection with a directory of information sources, such as the Open Directory Project on the Internet, to represent directory entries and categories of entries.

In one embodiment, a tag is used by the provider of a web page to identify the image(s), video, audio, or other multimedia content on the web page that the provider considers to be the most relevant for purposes of representing the nature and content of the web page. In one embodiment, a different tag is used for each type of multimedia content (e.g., one for each of static images, video, audio, etc.)

In one embodiment, a system and method are disclosed for presenting information. Categories are determined for found information by analyzing the content of the information. The categories are correlated with images that represent the categories. Images are displayed that correspond to the categories.

In one embodiment, a system and method are disclosed for presenting information. Textual content of the information is analyzed. The textual content is associated with image content. The image content is displayed to illustrate the information.

In one embodiment, a system and method are disclosed for building enriching content for a video presentation. Metadata related to the presentation is analyzed. Content is associated with the video presentation based on the analysis. The content is presented along with the video presentation.

These and other features and advantages of the present invention will be presented in more detail in the following detailed description and the accompanying figures which illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram illustrating a system used in one embodiment to provide a visual representation of search results.

FIG. 2 is a flowchart of a process used in one embodiment to provide a visual representation of database search results in response to a user query.

FIG. 3 is a block diagram illustrating the organization of a database 300 stored in database 106 of FIG. 1 in one embodiment.

FIG. 4 is a process flow showing in more detail a process used in one embodiment to implement step 204 of FIG. 2.

FIG. 5 is a flowchart illustrating a process used in one embodiment to process web pages as described in step 206 of FIG. 2.

FIG. 6 is a flowchart illustrating the process used in one embodiment to implement step 208 of FIG. 2.

FIG. 7 is a flowchart illustrating a process used in a one embodiment to implement step 210 of FIG. 2.

FIG. 8 is an exemplary search result categories display 800 used in one embodiment to display exemplary search result categories for a hypothetical search using the word “heart” as the search query.

FIG. 9 is an exemplary responsive web pages display 900 used in one embodiment to implement step 708 of FIG. 7.

### DETAILED DESCRIPTION

A detailed description of a preferred embodiment of the invention is provided below. While the invention is described in conjunction with that preferred embodiment, it should be understood that the invention is not limited to any one embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

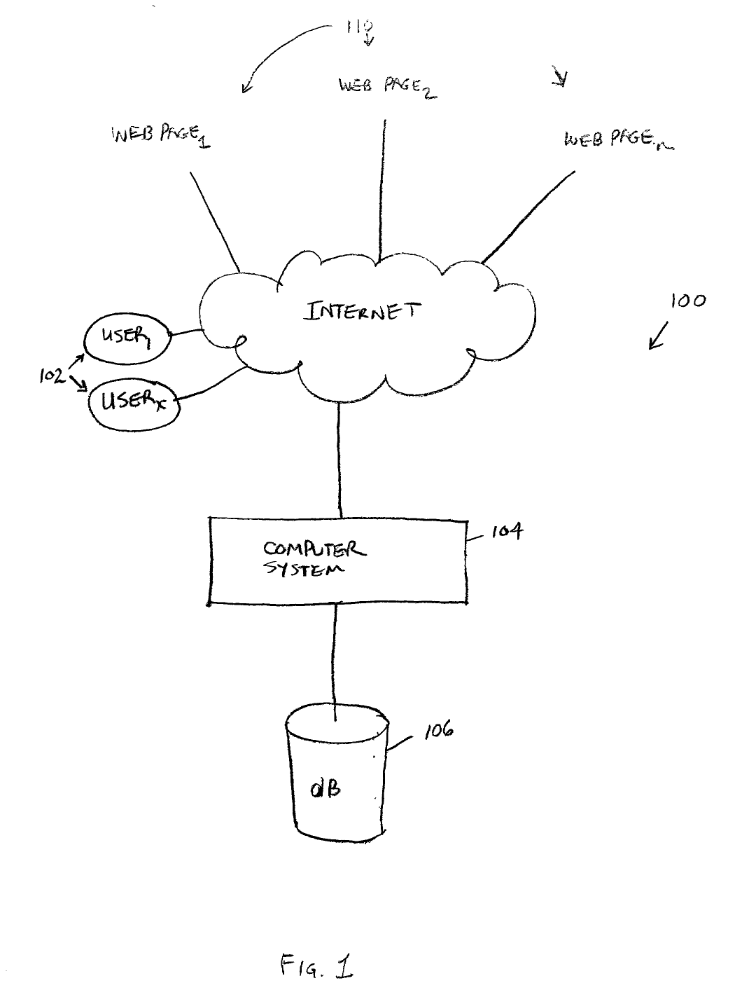

FIG. 1 is a block diagram illustrating a system used in one embodiment to provide a visual representation of search results. One or more users 102 connect via the Internet with a search engine website system 100 used to provide a search engine web site by means of computer system 104 and database 106. In one embodiment, computer system 104 comprises a super computer comprised of multiple computer processors and adequate memory, data storage capacity, and Internet bandwidth to provide search engine services via the Internet to multiple users simultaneously. In one embodiment, computer system 104 is configured to provide a web page via the Internet and to receive and process search queries received from users via the web page. The computer system 104 is connected to database 106 and is configured to store data in database 106 and to retrieve data stored in database 106.

In one embodiment, computer system 104 is comprised of at least two computers. One computer is configured as a front end web server configured to provide a web page via the Internet capable of receiving search queries from users via the Internet. The front end web server performs the specialized task of presenting web pages to users and acting as an interface or conduit for information between the separate computer or computers used to process and generates results for search queries, on the one hand, and users of the web site, on the other hand. In such an embodiment, the logic functions necessary to process and provide results for search queries are performed by one or more additional computers configured as business logic servers. The front end web servers maintain a direct connection to the Internet and a connection to the business logic server or servers. The business logic server(s) in turn are connected to database 106 and are responsible for storing information to database 106 and retrieving information from database 106 to be processed by the business logic servers and/or to be provided to users via the front end web server(s).

The search engine website system 100 also is connected via the Internet to a plurality of web pages 110, denominated as web page₁ through web pageₙ in FIG. 1. Given the number of web pages currently available on the Internet, the number of web pages that may be accessible via a search engine such as one provided by search engine website system 100 may be on the order of tens of millions or hundreds of millions of web pages.

In order to be able to process search queries and identify responsive web pages, the computer system 104 is configured to access the web pages 110 in advance of receiving search queries from users 102 in order to build a database of information necessary to identify web pages that are responsive to a search query and provide an efficient, useful, and visual representation of the search results. The computer system 104 may access the web pages 110 using any one of a number of readily available tools to perform that task, such as commercially available web crawler products that contain computer instructions necessary for a computer system such as computer system 104 to access a large number of web pages systematically by crawling from one page to the next, and so on. As each web page is accessed, information about the web pages is gathered and processed as described more fully below. The information gathered about the web pages 110 is stored in database 106 by computer system 104.

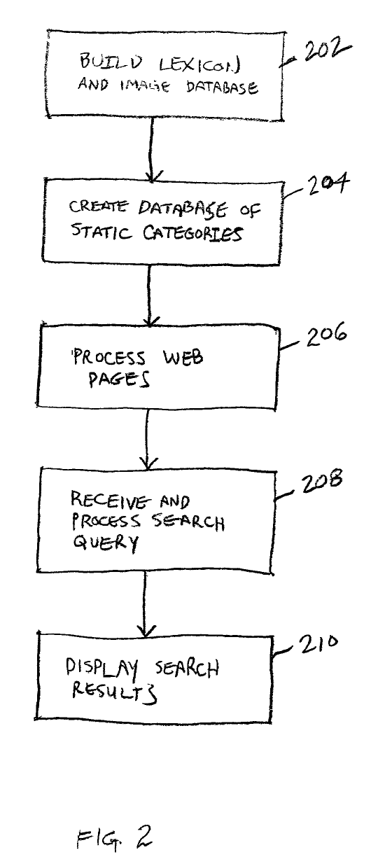

FIG. 2 is a flowchart of a process used in one embodiment to provide a visual representation of database search results in response to a user query. The process begins with a step 202 in which a lexicon and an image database are built. The lexicon 204 comprises a mapping of words, phrases and idiomatic expressions used in a given language, and their semantic, logical, and conceptual relationship to one another. In one embodiment, the lexicon 204 includes a mapping of collocations, i.e., the frequency with which words appear together in a language. Statistical natural language processing techniques for developing such a lexicon are well known in the art of linguistics. See, e.g., Automatic Text Processing: The Transformation, Analysis and Retrieval of Information by Computer, by Gerard Salton (Addison Wesley Publisher Co., reprinted December 1988); Foundations of Statistical Natural Language Processing, by Christopher D. Manning and Hinrich Schüitze (MIT Press 1999); and Lexical Acquisition: Exploiting On-Line Resources to Build a Lexicon, edited by Uri Zernik (Lawrence Erlbaum Assoc. 1991), which are hereby incorporated by reference for all purposes.

The lexicon is derived from a corpus of language content. The corpus is comprised of a very large body of content drawn from a wide variety of sources. The corpus may include raw content drawn from sources such as encyclopedias, newspapers, academic journals, and/or any of the multitude of content sources available on the Internet. Corpora developed for purposes of developing a lexicon through statistical natural language processing also are available. Some such corpora include tags or annotations that may be useful in building a lexicon, such as tags relating to sentence structure and tags identifying parts of speech. Automated statistical natural language processing techniques are applied to the corpus to build a lexicon to be used by search engine website system 100 of FIG. 1.

In one embodiment, the images database is comprised of images drawn from web pages accessed via the Internet. In one embodiment, the images database also includes images drawn from other sources, such as databases of images available on the Internet or commercially for use as clip art. In one embodiment, images generated by graphical designers or artists for the express purpose of being included in the images database also are included. In one embodiment, one or more images in the database are modified by adding a title, caption, or ticker associated with the image. Such metadata that is included with the image can be used to help determine a signature for each image. The image signature identifies the words, phrases, expressions, and concepts the image may be useful in representing. The image signature is stored. The image signature may be derived by noting the context of the page in which the image is displayed and assuming that the image is relevant to that context. The process continues with step 204 in which a database of static categories is created. As described more fully below, the static categories will be used, when suitable, to organize database records identified in response to a search query into categories for more convenient and efficient review by the user. The term “static” categories refers to the fact that the categories developed in step 204 are created in advance and do not change in response to a particular query or set of search results. As described more fully below, in one embodiment additional or different categories are created dynamically in some circumstances, such as where the responsive records cannot be grouped into a reasonable number of static categories that accurately described the content of the records in the group.

Next, in step 206, individual web pages are processed to develop a signature for each page. The signature embodies information concerning the identity, location, nature, and content of each of the web pages 110 to be included in the database. In addition to developing a signature for each page, the images contained in each page are evaluated and, if usable, are added to the images database and associated with the web page as an image suitable for providing a visual representation of the content of the page. If no image, or an insufficient number of images, taken from a web page is identified as suitable for providing a visual representation of the content of the page, other images from the images database, or a picture of the web page itself as viewed by a browser, are associated with the page.

Then, in step 208, a search query is received from the user and processed. Responsive web pages are identified and grouped into appropriate static and/or dynamic categories and result categories and responsive web pages within each category are ranked, as described below.

Finally, in step 210, search results are displayed to the user using a visual representation described more fully below.

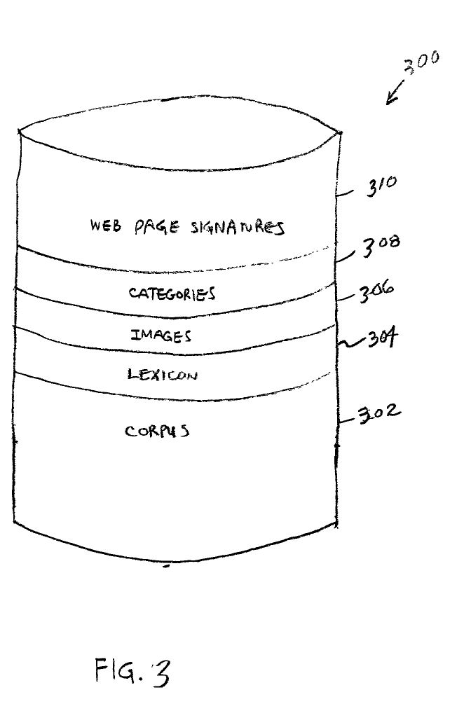

FIG. 3 is a block diagram illustrating the organization of a database 300 stored in database 106 of FIG. 1 in one embodiment. The database includes a corpus database 302 used to store the corpus described above. The database also includes a lexicon 304, built using the corpus, as described above. The third component of the database 300 is the images database 306.

The database 300 also includes a categories database 308. Finally, the database 300 includes a web page signatures database 310 in which the signature of each web page and an identification of the image(s) associated with the web page are stored.

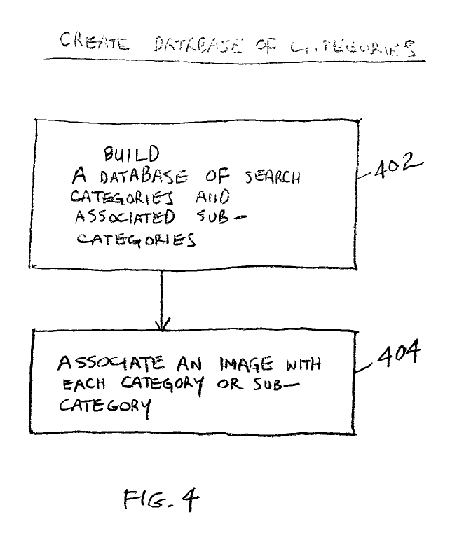

FIG. 4 is a process flow showing in more detail a process used in one embodiment to implement step 204 of FIG. 2. The process begins with a step 402 in which a database of static search categories and associated subcategories is built. An effort is made to anticipate the topics, types of search, and types of information users may be interested in finding by means of queries submitted to the search engine website. The lexicon described above is used in one embodiment to develop categories and associated subcategories that may be useful in presenting search results. In one embodiment, the lexicon is used to identify words, phrases, and/or expressions that have a close semantic or conceptual relationship with a word or combination of words that it is anticipated may be included in a query. These related words, phrases, and/or expressions are then stored as static categories and subcategories associated with the word or combination of words.

Next, in step 404, at least one image from the image database is associated with each category or subcategory stored in the category database. As noted above, when images are stored in the image database, information about the image and the words and concepts the image may be appropriate to represent also are stored in the database. This information is used to match images from the database with corresponding categories and subcategories in the category database so that an image may be used to provide a visual representation of the category to a user.

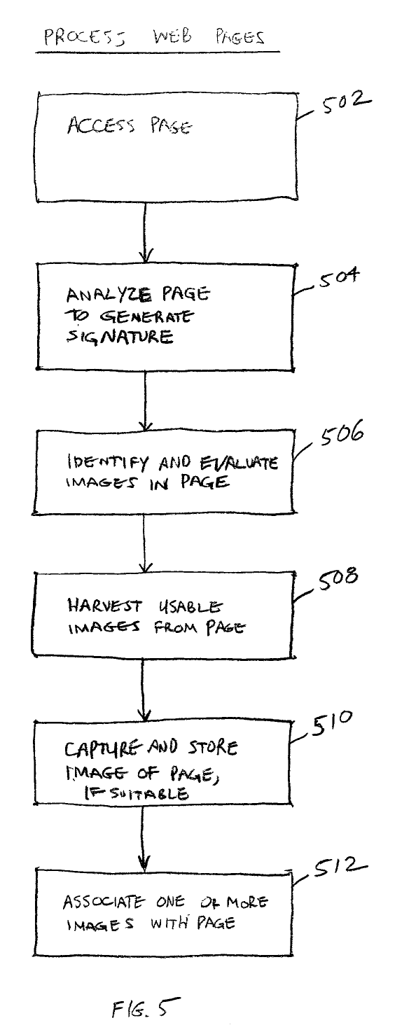

FIG. 5 is a flowchart illustrating a process used in one embodiment to process web pages as described in step 206 of FIG. 2. Each step in the flowchart shown in FIG. 5 is performed with respect to each web page accessed in the manner described above, such as using a web crawler. The process begins with step 502 in which the web page is accessed. Next, in step 504, the page is analyzed to generate a signature for the page. This process includes the application of well known statistical natural language processing techniques to the text content of the web page to identify the words, subjects, and concepts that are the primary, or a significant, focus of the content of the page.

In addition, the HTML (hypertext markup language) or other computer code used to display the web page to those accessing the web page is analyzed to extract information about the page that may not be available from the text content of the page itself. For example, computer programming languages such as HTML provide a way to tag information in the code, such as to indicate the meaning, nature, or significance of the information. A standard setting body establishes standards for the use of such tags to annotate the code. One well known application of such tags is the use of a tag to identify keywords that the providers of the page believe describe the nature and content of the page. Such keywords may be used, in addition to information derived from the natural language processing techniques referred to above, to develop a signature for the page. The signature will later be used to identify pages responsive to a query from a user.

The process continues with step 506 in which the images included in the web page are identified and evaluated. In one embodiment, all GIF and JPEG files on a web page, and all code associated with such files, is evaluated. GIF and JPEG files are commonly used to provide graphical images on web pages. In one embodiment, an automatic parsing algorithm is used to determine whether each image on a web page may be suitable to be added to the images database, either for use in representing a category or subcategory of information, or to be used to provide a visual representation of the content of either the page from which it is harvested or another web page that contains information related to the image but that does not itself have images suitable for use in representing the page. The properties of each image that are evaluated include the location of the image within the page, whether the image has a subject or title associated with it, the way the image is referred to in the text on the web page, and the size of the image and its associated computer file. For example, an image that is relatively large, centrally located, and annotated with a title or caption that correlates with the signature of the page may be selected as an image suitable for representing the content of the page. By contrast, an image that is small, has no text associated with it, and appears on the bottom or periphery of the web page may be rejected.

In step 508, images on the page that may be usable to represent either a search category, the page itself, or some other page are harvested from the page and stored in the images database. As noted above, a signature for the image also is stored.

Next, in step 510 the overall appearance of the web page itself is evaluated to determine whether a picture of the entire web page should be captured and stored in the database. For example, a web page that contains a large image or several images closely related to the signature for the web page may be represented visually by a reduced size image of the entire web page. Products and services for obtaining such reduced size images of entire web pages are available commercially, including products and services that provide a GIF capture of a target web page.

In one embodiment, the above-described techniques for identifying images in a web page that may be suitable for providing a visual representation of the web page are replaced or augmented by enabling providers of web pages to identify the images on the page that the provider believes are the most relevant or useful. For example, providers could be provided with a way to tag the HTML or other code used to provide the page in a manner that identifies the image or images on the web page that the provider of the web page believes are the most relevant or important images on the page, or the ones most suitable to be used to provide a visual representation of the page such as to present search results. A standard for such tagging of images has not yet been provided, but could readily be established by the standard setting bodies for languages, such as HTML, that are commonly used to provide web pages. For example, such a standard could easily be modeled on the standard that currently enables providers of web pages to identify keywords for a web page.

The process shown in FIG. 5 concludes with step 512 in which one or more images form the images database are associated with the web page. Preferably, the images associated with the web page will be images harvested from the page itself. However, in cases where the web page itself did not have a sufficient number of images suitable for use in providing a visual representation of the page as a search result, as described above other images from the images database having a signature or description that matches the signature of the page may be drawn from the images database to be associated with the web page for future use in providing a visual representation of the page.

In one embodiment, a score is assigned to the web page and stored in the web page signature database to provide an indication of the extent to which the page contains high quality images and/or other media content that is relevant to the main information contained in the page. In one embodiment, this assessment of the visual and/or multimedia content of each web page is used, among other factors, to determine a relative ranking for each web page identified as responsive to a query. Using this approach, web pages that are rich in visual and/or multi-media content are more likely to receive a higher ranking and, therefore, to appear in one of the first several layers or pages of search results presented to the requesting party. In many cases, this approach will result in a search results display that is more visually interesting and familiar to the requesting party.

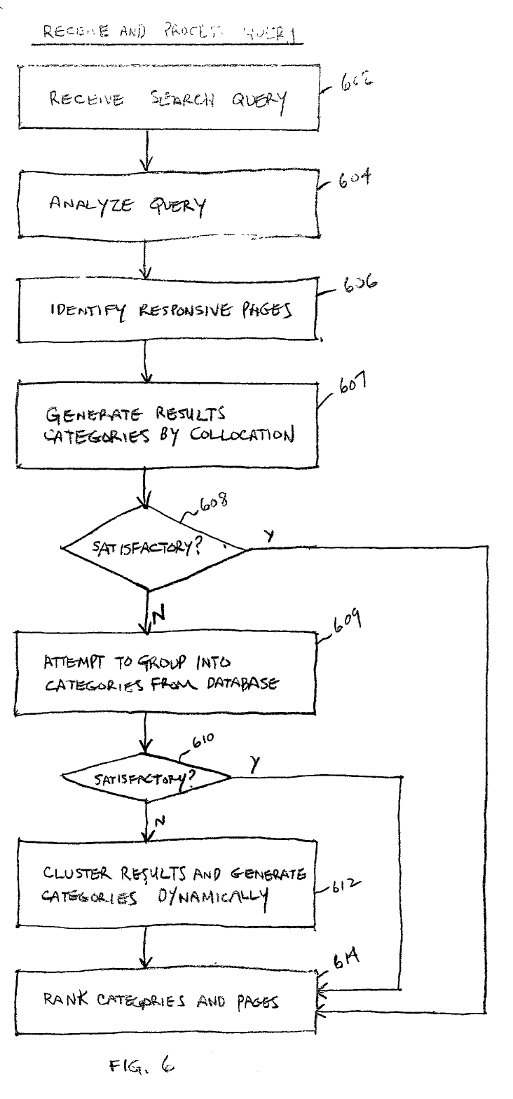

FIG. 6 is a flowchart illustrating the process used in one embodiment to implement step 208 of FIG. 2. The process begins with step 602 in which a search query is received from a user. Next, in step 604 the query is analyzed to determine the words, phrases, expressions, and concepts most closely associated with the word or combination of words provided by the user in the query. Next, in step 606 the database of web page signatures is searched to identify web pages having a signature that matches in whole or in part the word or combination of words in the query.

Then, in step 607, tentative search result categories are generated dynamically using collocations. That is, the lexicon is used to identify words or phrases that often appear together with one or more search terms or phrases. Next, in step 608, it is determined whether the categories generated based on the collocations are satisfactory. The signatures of the responsive web pages are searched to determine if the collocations are associated with a significant portion of the web pages such that the collocations provide a satisfactory means of grouping the results (e.g., by defining a manageable number of categories that include most of the web pages and with sufficient distribution of pages among the categories).

If the categories based on collocations are satisfactory, the process proceeds to step 614, in which the categories are ranked in terms of how closely they are related to the query. Also, the responsive web pages within each category are ranked within the category based on how closely the signature for each web page matches the query. Specific techniques for performing such ranking are well known in the art and are beyond the scope of this disclosure.

If the categories based on collocations are not satisfactory, the process continues with step 609, in which an attempt is made to associate the responsive web pages with previously-defined categories from the categories database. In one embodiment, the categories most closely related to the signature for each web page are identified and assigned a weight indicating how closely the category matches the signature. The weighted static categories are then evaluated in step 610 to determine if the responsive web pages can be grouped within a reasonable number of static categories that will both encompass a sufficient number of the web pages and describe the nature and content of the web pages within each group adequately. In one embodiment, the weighted static categories are evaluated to determine whether the responsive results may be represented adequately by from one to ten static categories.

If the static categories do provide a satisfactory grouping and representation of the responsive web pages, the process proceeds to step 614 in which the categories and responsive web pages are ranked. If in step 610 it is determined that the matching of responsive web pages to static categories has not resulted in a satisfactory grouping and representation of the search results, the process proceeds to step 612 in which well known statistical techniques are used to group the responsive web pages into clusters of related responsive web pages based on the signature of each page. Statistical natural language processing techniques are then used to generate a category name dynamically for each cluster. Then, the process proceeds to step 614, in which the dynamically generated categories are ranked and the web pages within each category are ranked, as described above.

The process begins with step 702 in which images associated with the categories to be displayed are retrieved from the images database. Next, in step 704, a web page is generated to provide a visual representation of the result categories. Then, in step 706, the images associated with the web pages to be presented as search results are retrieved from the images database. Finally, in step 708, one or more web pages are generated to provide a visual representation of the responsive web pages within each category.

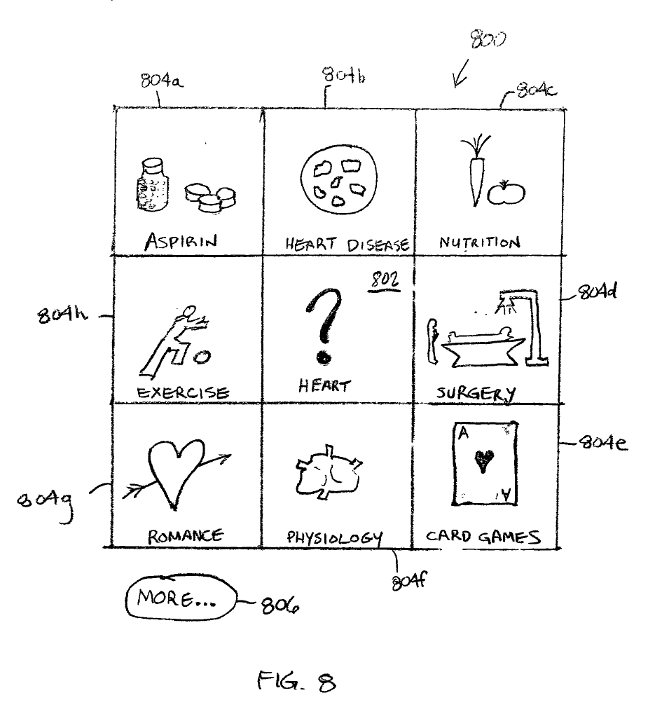

FIG. 8 is an exemplary search result categories display 800 used in one embodiment to display exemplary search result categories for a hypothetical search using the word “heart” as the search query. As shown in FIG. 8, the search result categories display 800 is divided into a 3×3 grid of 9 cells. The center cell 802 contains an image of a question mark and the text of the search query, in this case the word “heart”. The remaining 8 cells of the grid, cells 804a-804h, are used to provide a visual representation of the eight top ranked search result categories. The exemplary categories shown in FIG. 8 include the categories “aspirin”, “heart disease”, “nutrition”, “surgery”, ”card games”, “physiology”, “romance”, and “exercise”. In each of cells 804a-804h, the name of the category displayed in the cell is listed at the bottom of the cell and an image that provides a visual representation of the result category is displayed in the cell above the category name. The search result categories display 800 also includes a button 806 which, when selected, will result in the next eight categories by rank (or the remaining categories, if less than eight remain) being displayed in the search results categories display 800. While the exemplary categories display 800 presents eight categories at a time, it is readily apparent that any number of categories may be displayed at one time, and that geometries other than the 3×3 grid geometry show in FIG. 8, such as a hub and spoke arrangement, can be used.

The search results categories display 800 provides an efficient and aesthetically pleasing way for the user to find and access the responsive web pages that are most likely to contain the information the requesting party is seeking. For example, a requesting party interested in the latest information available about the benefits and risks of taking aspirin as a preventive measure prior to the onset of heart disease would be drawn quickly to the image of a bottle of aspirins and several aspirin tablets displayed in cell 804a of FIG. 8. The requesting party likewise would be able to quickly filter out wholly irrelevant information, such as web pages grouped under the category “romance”, by recognizing that the image of the heart shape with an arrow through it is an image related to the heart as a symbol of romantic love, and not a health-related concept.

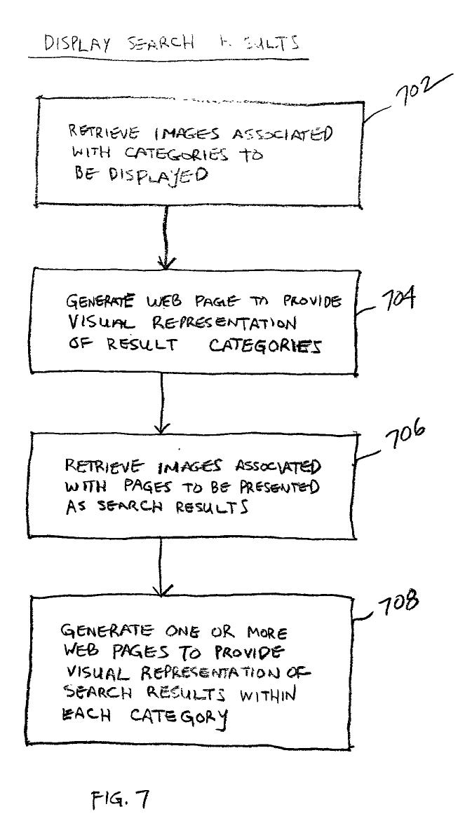

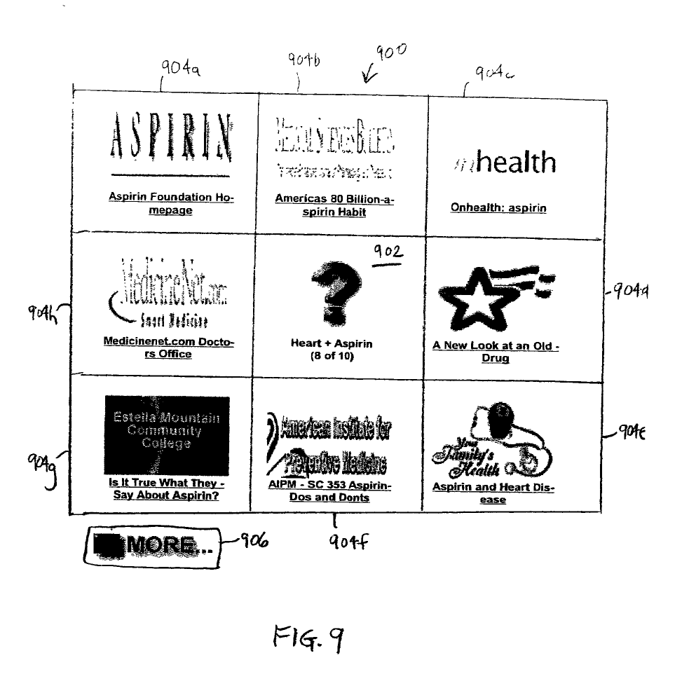

FIG. 9 is an exemplary responsive web pages display 900 used in one embodiment to implement step 708 of FIG. 7. The responsive web pages display 900 shown in FIG. 9 is a continuation of the example described above with respect to FIG. 8 in which the user has selected the category “aspirin”. The responsive web pages display 900 is divided into a 3×3 grid of 9 cells, similar to the display 800 in FIG. 8. The center cell 902 contains the same question mark image as center cell 802 in FIG. 8. The text that appears beneath the image in center cell 902 indicates that the responsive web pages display 900 is being used to display web pages responsive to a query comprised of the search term “heart” that have been grouped within the category named “aspirin”. The text also indicates that the display is being used to show eight of ten responsive websites in the category being displayed.

In the outer cells 904a-904h, each cell is used to provide a visual representation of one of the eight top ranked responsive web pages within the category “aspirin”. In one embodiment, a single representative image previously associated with each web page appears in the cell corresponding to the responsive web page. In one embodiment, multiple images are associated with each web page in the database and an animated slide show of images associated with the web page is presented for each web page displayed. As shown in FIG. 9, in one embodiment, text appears beneath the image or images displayed for each web page describing the nature, location, source, and/or content of the responsive web page.

The responsive web pages display 900 also includes a more pages button 906 which, when selected, results in the next zero to eight responsive web pages being displayed. In the case illustrated in FIG. 9, only two additional websites within the category “aspirin” would be displayed.

In one embodiment, the slide show images are rotated at relatively slow intervals when the cursor is not on a particular one of cells 904a-904h and the pace of the slide show accelerates appreciably when the cursor is placed on a particular one of cells 904a-904h. This permits the requesting party to quickly view the set of images associated with a particular responsive web page by placing the cursor on the slide show for that page.

The above-described visual representation of search result categories and responsive web pages enables users to find desired information more quickly and efficiently by using a visual interface, which is much more familiar to users of the Internet than the traditional list approach. In addition, the slide show approach is advantageous because it enables a requesting party to do the equivalent of flipping through pages of a book or magazine on a bookshelf in a bookstore. By viewing the slide show, a requesting party can quickly get a sense of the nature of a web page and the content the user will find if the user accesses the page. By contrast, when search results are presented in a list or folder format, a requesting party must spend time reading a written description of each web page that may or may not provide an accurate indication of the content of the web page. Furthermore, the above-described approach saves on the number of mouse or other pointer “clicks” needed to review search results and find information, as a user can in many cases get more complete information regarding the multimedia content of a page without actually visiting the page.

It should be noted that while the above detailed description focuses on a particular embodiment in which images are used to provide a visual representation of search result categories and responsive web pages, it is contemplated that the approach described above will be used with other forms of content available in sources of information such as the Internet. For example, there is a wealth of video content available on the Internet. Such video content could be accessed, evaluated, and harvested in the same manner as described above for static images. Harvested video could be associated with search result categories and web pages as described above with respect to the static images, and used in displays similar to those shown in FIGS. 8 and 9 to represent search categories and responsive web pages respectively.

In such a video embodiment, segments of video would be selected to represent search result categories or responsive web pages in the same manner as described above for static images. The video clips would then be presented in reduced form in the same manner as shown in FIGS. 8 and 9. Such video clips would have the same advantage as static images, presented either singly or in a slide show as described above, in permitting a requesting party to quickly determine which categories of information and which responsive web pages within categories of interest are most likely to contain the information the requesting party is seeking. Audio clips likewise can be used to provide a multimedia representation of the nature and content of a web page in the same manner as described above with respect to images and video.

While the above description focuses on an embodiment in which the database being searched is a database of web pages available via the Internet, the approach is equally applicable to presenting search results in response to a query of any database of information in which the database records may be represented by an associated image or set of images. Contemplated applications include interactive television applications. For example, a viewer of a sporting event on television may be provided with a cursor or other pointing device to be used to select images on the screen concerning which the requesting party would like to retrieve additional information. Alternatively, a viewer may be provided with a means for entering a search query in the form of text related to a program the viewer is viewing. In either case, a visual representation of search results such as those shown in FIGS. 8 and 9, and described above would be an advantageous and visually pleasing way to present search results on the television screen to such a viewer.

In another interactive television embodiment, a database of information is accessed to provide a parallel presentation to a television broadcast or video presentation. Information about the broadcast is derived by either analyzing the broadcast or metadata associated with the broadcast such as a datacast and querying the database based on what is being broadcast to find and present information that is related to the broadcast. For example, close caption information associated with the broadcast may be used to determine the broadcast content and search for related material.

In other embodiments, the search techniques described above may be used to search for and present material included on a DVD or other medium in addition to material found on the Internet.

Although the foregoing invention has been described in some detail for purposes of clarity of understanding, it will be apparent that certain changes and modifications may be practiced. It should be noted that there are many alternative ways of implementing both the process and apparatus of the present invention. Accordingly, the present embodiments are to be considered as illustrative and not restrictive, and the invention is not to be limited to the details given herein.

What is claimed is:

1. A method of presenting a search result comprising:
determining categories for found information by analyzing the content of the information;
correlating the categories with images that represent the categories; and
displaying images that correspond to the categories.

2. A method of presenting a search result as recited in claim 1 wherein images corresponding to the found information are displayed when a user activates one of the categories.

3. A method of presenting a search result as recited in claim 2 wherein the user activates one of the categories by dragging a cursor over the image that corresponds to the category.

4. A method of presenting a search result as recited in claim 1 wherein the display is a grid.

5. A method of presenting a search result as recited in claim 1 wherein the information includes a plurality of web sites.

6. A method of presenting a search result as recited in claim 5 further including providing a rotating display of content from the web sites.

7. A method of presenting a search result as recited in claim 5 further including providing a video display of content from the web sites.

8. A method of presenting a search result as recited in claim 5 further including rating each web site according to whether the web site includes image content that is relevant to textual content on the web site.

9. A method of presenting a search result as recited in claim 1 wherein the information includes information stored on a DVD.

10. A method of presenting a search result as recited in claim 6 wherein dynamically displaying content from the web sites includes showing representative images from the web site that correspond to textual content in the web site.

11. A system for presenting a search result comprising:
a processor configured to determine categories for found information by analyzing the content of the information;
a database containing images that correspond to the categories; and
a processor configured to generate a display of images that correspond to the categories.

12. A computer program product for presenting a search result, the computer program product being embodied in a computer readable medium and comprising computer instructions for:
determining categories for found information by analyzing the content of the information;
correlating the categories with images that represent the categories; and
displaying images that correspond to the categories.

13. A method of presenting information comprising:
analyzing textual content of the information;
associating the textual content with image content; and
displaying the image content to illustrate the information.

14. A method of presenting information as recited in claim 13 wherein the image content is included in the information.

15. A method of presenting information as recited in claim 13 wherein the image content is not included in the information.

16. A method of presenting information as recited in claim 13 wherein metadata associated with the image content is correlated with the textual content to determine the image content that is associated with the textual content.

17. A method of presenting information as recited in claim 13 wherein the information includes a web site.

18. A method of summarizing a web site comprising:
reading tags associated with a web site wherein certain of the tags indicate that material associated with the tags is representative material; and
displaying the representative material as a representative of the website.

19. A method of summarizing a web site as recited in claim 18 further including displaying the representative material in response to a search request.

20. A computer program product for presenting information, the computer program product being embodied in a computer readable medium and comprising computer instructions for:
analyzing textual content of the information;
associating the textual content with image content; and
displaying the image content to illustrate the information.

21. A system for presenting information comprising:
a processor configured to analyze textual content of the information and associate the textual content with image content; and
a display configured to display the image content to illustrate the information.

22. A method of building enriching content for a video presentation comprising:
analyzing metadata related to the presentation;
associating content with the video presentation based on the analysis; and
presenting the content along with the video presentation .

23. A method of building enriching content for a video presentation as recited in claim 22 wherein the metadata is close caption information.

24. A method of building enriching content for a video presentation as recited in claim 22 wherein the metadata is obtained from datacasting.

25. A method of building enriching content for a video presentation as recited in claim 22 wherein the content is downloaded from the Internet.

26. A method of building enriching content for a video presentation as recited in claim 22 wherein the video presentation is presented in an interactive television system.

27. A computer program product for building enriching content for a video presentation, the computer program product being embodied in a computer readable medium and comprising computer instructions for:
analyzing metadata related to the presentation;
associating content with the video presentation based on the analysis; and
presenting the content along with the video presentation .

28. A system for building enriching content for a video presentation comprising:
a processor configured to analyze metadata related to the presentation and associate content with the video presentation based on the analysis; and
a display configured to present the content along with the video presentation.
